(19) United States
(12) Patent Application Publication
(10) Pub. No.: US 2006/0152772 A1
(43) Pub. Date: Jul. 13, 2006

(54) Image scanner, and image sensor head built therein

(75) Inventor: Hideki Sawada, Kyoto (JP)

Correspondence Address: HAMRE, SCHUMANN, MUELLER & LARSON, P.C., P.O. BOX 2902-0902, MINNEAPOLIS, MN, 55402, US

(73) Assignee: Rohm Co., Ltd., Kyoto (JP)

(21) Appl. No.: 10/542,079

(22) PCT Filed: Jan. 15, 2004
(86) PCT No.: PCT/JP04/00263

§ 371 Date: Jul. 13, 2005

(30) Foreign Application Priority Data
Jan. 17, 2003 (JP) 2003-009201

(51) Int. Cl. H04N 1/04

(52) U.S. Cl. 358/474

(57) ABSTRACT

A flatbed type image sensor (A) includes a case (20) that is elongated in the primary scanning direction (N1) and mounted on a bracket (6) movable in the secondary scanning direction (N2). The case (20) accommodates a light source and a plurality of light receiving elements. The light receiving elements receive light from a document to be read. The case (20) is provided with two positioning means (71) for preventing the case from moving in the primary scanning direction (N1) relative to the bracket (6). These positioning means are spaced from each other in the primary scanning direction (N1).

### TECHNICAL FIELD

The present invention relates to an image scanner used for reading an image on a document. The present invention further relates to an image sensor head incorporated in such an image scanner.

### BACKGROUND ART

FIG. 8 illustrates an example of a conventional image scanner. The illustrated image scanner 100 is a flatbed type and includes a housing 101 and a transparent glass plate 111 attached to the upper portion of the housing. A document to be read is placed on the glass plate 111. The housing 101 accommodates an image sensor head 102 and a drive assembly 105. The image sensor head 102 is elongated in the primary scanning direction N1. The drive assembly 105 reciprocates the image sensor head 102 in the secondary scanning direction N2.

The housing 101 includes a first portion 101a containing a control panel 112 and a second portion 101b to which the glass plate 111 is attached. The control panel 112 is provided with a power switch and operation buttons (both not shown). The control panel 112 is arranged at an upper left corner of the housing 101.

As shown in FIG. 9, the image sensor head 102 includes an elongated case 120, a board 124 attached to the underside of the case 120, a light source 131 mounted at an end of the board 124, a light guide 132, a reflector 133, an lens array 141, and a plurality of sensor ICs 142.

The drive assembly 105 is a belt drive mechanism using a timing belt 152. The timing belt 152 is provided with a supporting bracket 106 for supporting the image sensor head 102. The supporting bracket 106 is movably supported by guide rods 160 extending in the secondary scanning direction.

When the image scanner 100 is working, the image sensor head 102 is reciprocally moved by the drive assembly 105 in the secondary scanning direction N2. In such an instance, displacement of the image sensor head relative to the supporting bracket 106 is not preferable for obtaining an image of high quality. In view of this, the image scanner 100 is provided with positioning means described below.

As shown in FIG. 9, the case 120 includes ends each formed with a first engaging means 121 having a projection 121a. On the other hand, the supporting bracket 106 includes an upper surface formed with a second engaging means 162 having a hole 162a in which the projection 121a is fitted. The projection 121a and the hole 162a engage with each other, such that the position of the image sensor head 102 in the secondary scanning direction N2 is fixed relative to the supporting bracket 106. Further, one of the first engaging means 121 is formed with a recess 171 in the vicinity of the projection 121a. On the other hand, a post 172 is provided in the vicinity of the second engaging means 162 corresponding to this first engaging means 121. The post 172 and the recess 171 engage with each other, such that the position of the image sensor head 102 in the primary scanning direction N1 is fixed relative to the supporting bracket 106.

As shown in FIG. 8, the image sensor head 102 and the control panel 112 are connected to each other via a flexible cable 113. As shown in FIG. 9, the board 124 of the image sensor head 102 is provided with a connector 114 which is connected to the flexible cable 113. The connector 114 is attached to the left end of the board 124.

In the image scanner shown in FIG. 8, the control panel 112 is arranged at the upper left corner of the housing 101. However, another type of image scanner may be desired, where the control panel 112 is arranged differently. FIG. 10 illustrates an image scanner 100B which is a modified example of the conventional image scanner shown in FIG. 8. In this scanner, the control panel 112 is arranged at the lower left corner of the housing 101. The image scanner 100B may include an image sensor head 102B shown in FIG. 11. In the image sensor head 102B, the connector 114 is attached to the board 124 at a position corresponding to the arrangement of the control panel 112. Specifically, the connector 114 is provided at the right end (as seen in FIG. 11) of the board 124. This position is opposite to the position of the connector shown in FIG. 9.

In light of cost reduction, the above-described image sensor head 102B may be manufactured by using the same case as the case 120 used for the conventional image sensor head 102. In this instance, as shown in FIG. 11, the positioning recess 171 formed at the conventional case 120 is arranged at a position largely apart from the connector 114.

As seen from FIG. 10, when the image sensor head 102B is moved in the secondary direction N2, an external force from the flexible cable 113 is applied to the right end of the image sensor head 102B via the connector 114. In such an instance, with the arrangement shown in FIG. 11, the working point of the above external force is apart from the recess 171. As a result, the image sensor head 102B may be displaced in the primary scanning direction N1 in reading operation.

### DISCLOSURE OF THE INVENTION

The present invention has been conceived under the above-described circumstances. It is therefore an object of the present invention to provide an image sensor head which suffers less displacement in reading operation than the conventional one. Another object of the present invention is to provide an image scanner incorporating such an image sensor head.

An image sensor head according to a first aspect of the present invention comprises: a case elongated in a primary scanning direction and mounted on a bracket movable in a secondary scanning direction; a light source accommodated in the case; and light receiving elements accommodated in the case for receiving light from a document to be read. The case is provided with at least two positioning means for preventing the case from moving in the primary scanning direction relative to the bracket, where these positioning means are spaced from each other in the primary scanning direction.

Preferably, each of the positioning means comprises a recess into which a post provided at the bracket is fitted.

Preferably, the image sensor head according the present invention further comprises: an elongated circuit board fixed to the case; and a connector supported by the board for external connection. The light source may be mounted on an end of the board, while the connector may be attached to another end of the board.

Preferably, the image sensor head may further comprise an elastic member contacting with the board for urging the case.

Preferably, the image sensor head may further comprise at least two cylindrical projections for preventing the case from moving in the secondary scanning direction relative to the bracket. Each cylindrical projection may be positioned in the vicinity of a corresponding one of the positioning means, and may project in the primary scanning direction.

Preferably, an image scanner according to a second aspect of the present invention comprises: a case elongated in a primary scanning direction; a bracket that supports the case and is movable in a secondary scanning direction; a light source accommodated in the case; light receiving elements accommodated in the case for receiving light from a document to be read; a circuit board fixed to the case and supporting the light source and the light receiving elements; a connector attached to the circuit board for external connection; and a drive assembly for reciprocating the bracket in the secondary scanning direction. The case is provided with at least two positioning means for preventing the case from moving in the primary scanning direction relative to the bracket, where these positioning means are spaced from each other in the primary scanning direction.

Preferably, each positioning means comprises a recess formed at the case, while the bracket is provided with a post to be fitted into the recess.

Preferably, the connector is arranged between the two positioning means and located at a position close to one of these positioning means.

Preferably, the image scanner according to the present invention further comprises a flexible cable connected to the connector.

### BRIEF DESCRIPTION OF THE DRAWINGS

FIG. 1 is a perspective view illustrating basic components of an image scanner according to a first embodiment of the present invention.

FIG. 2 is an exploded perspective view illustrating an image sensor head incorporated in the scanner of FIG. 1.

FIG. 3 is a section view taken along lines III-III in FIG. 1.

FIG. 4 is a section view taken along lines IV-IV in FIG. 3.

FIG. 5 is a section view taken along lines V-V in FIG. 3.

FIG. 6 is a perspective view illustrating basic components of an image scanner according to a second embodiment of the present invention.

FIG. 7 is an exploded perspective view illustrating the image sensor head incorporated in the scanner of FIG. 6.

FIG. 8 is a perspective view illustrating basic components of a conventional image scanner.

FIG. 9 is an exploded perspective view illustrating an image sensor head incorporated in the scanner of FIG. 8.

FIG. 10 is a perspective view illustrating a modified example of the scanner in FIG. 8.

FIG. 11 is an exploded perspective view illustrating an image sensor head incorporated in the scanner of FIG. 10.

### BEST MODE FOR CARRYING OUT THE INVENTION

Preferred embodiments of the present invention are described below with reference to the accompanying drawings.

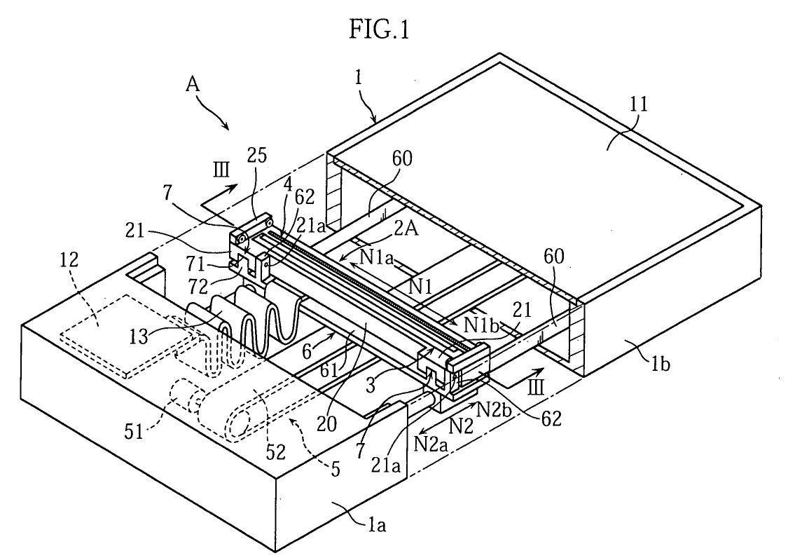

FIG. 1 illustrates an image scanner according to a first embodiment of the present invention. The illustrated image scanner (generally indicated by reference character A) is a flatbed type and includes a housing 1 and a transparent glass plate 11 attached to an upper portion of the housing 1. The housing 1 accommodates an image sensor head 2A, a drive assembly 5, and other components. The image sensor head 2A is elongated in the primary scanning direction N1. The drive assembly 5 reciprocates the image sensor head 2A in the secondary scanning direction N2. Normally, the image sensor head 2A is at a home position. In operation, the head 2A, starting from the home position, is moved in a direction N2b. Thereafter, the head 2A is moved in a direction N2a back to the home position.

The housing 1 is in a rectangular form that is longer in the secondary scanning direction N2 than in the primary scanning direction N1. The housing 1 includes a first portion 1a (at the left side in FIG. 1) and a second portion 1b (at the right side). The first portion 1a accommodates a control panel 12 for controlling the image scanner A, and also accommodates a motor 51. The control panel 12 includes a non-illustrated power switch and operation buttons, both protruding beyond the upper wall of the first portion 1a. The motor 51 is a component constituting the drive assembly 5.

The second portion 1b of the housing 1 supports the glass plate 11. The image sensor head 2A moves in the space of the second portion 1b.

A document to be read is placed on the glass plate 11. The glass plate 11 is large enough to hold documents of prescribed sizes.

The image sensor head 2A includes an elongated case 20, a light emitting assembly 3 for irradiating an image reading area, and a light receiving assembly 4 for receiving light from the image reading area. The structure of the light emitting assembly 3 and the light receiving assembly 4 will be described later.

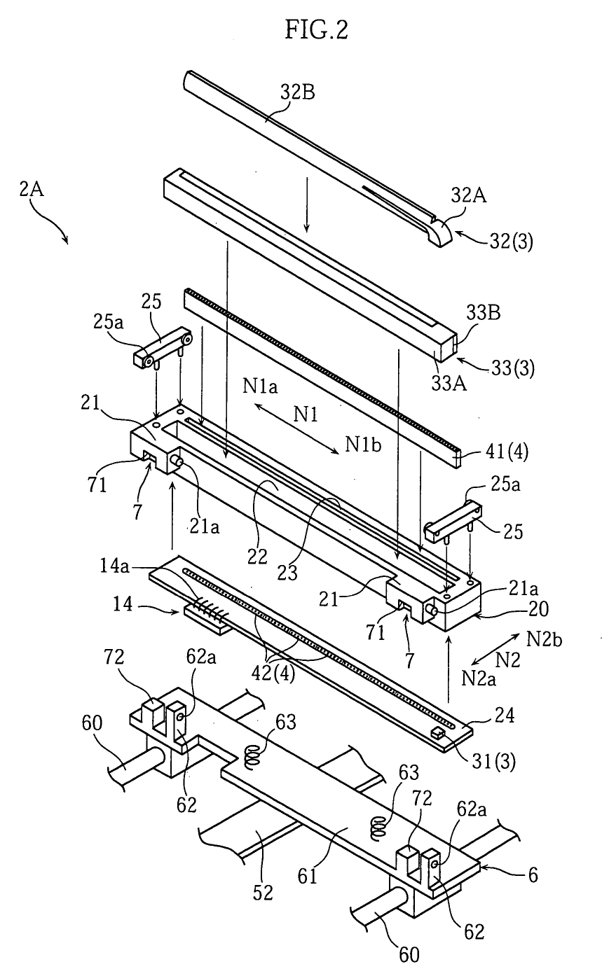

The drive assembly 5 includes a timing belt 52 to which a supporting bracket 6 is fixed. As shown in FIG. 2, the supporting bracket 6 includes a flat upper surface 61 for supporting the image sensor head 2A from below. The bracket 6 is movably supported by a pair of guide rods 60 extending in the secondary scanning direction N2.

The image sensor head 2A and the supporting bracket 6 are provided with engaging means for connecting these two components to each other. Specifically, as shown in FIG. 2, the case 20 includes a side surface formed with a pair of overhangs 21 spaced from each other, each overhang being disposed at a corresponding end of the case 20. The overhang 21 is provided with a cylindrical projection 21a extending in the primary scanning direction N1. Further, the overhang 21 is formed with a recess 71. In the illustrated example, the recess 71 is a space in the form of a cube or rectangular parallelepiped. As seen from FIG. 2, the recess 71 is open at the bottom and at one side.

Meanwhile, the upper surface 61 of the supporting bracket 6 is formed with a pair of first posts 62. Each of the first posts 62 is formed with a cylindrical hole 62a in which the projection 21a of the case 20 is fitted. Due to the fitting manner of the projection 21a and the hole 62a, the image sensor head 2A is positioned in the secondary scanning direction N2 relative to the supporting bracket 6. With the projection 21a fitted in the hole 62a, the image sensor head 2A is rotatable, relative to the supporting bracket 6, around an axis extending in the primary scanning direction N1. Springs 63 are provided between the image sensor head 2A and the supporting bracket 6 for urging the image sensor head 2A upwardly.

A plurality of guide rollers 25a are provided above the case 20. The rollers 25a are rotatably attached to bases 25 which in turn are fixed to the upper surface of the case 20. Due to the biasing force of the spring 63, the guide roller 25a is held in contact with the lower surface of the glass plate 11.

The upper surface 61 of the supporting bracket 6 is further formed with a pair of second posts 72. As shown in FIG. 2, each second post 72 is arranged adjacent to a corresponding first post 62. In the illustrated example, the second post 72 is shorter than the first post 62. Each second post 72 is fitted into a corresponding recess 71. Due to the fitting manner of the second post 72 and the recess 71, the position of the image sensor head 2A is fixed in the primary scanning direction N1 relative to the supporting bracket 6. According to the present invention, the projection 21a and the recess 71 may be formed at the supporting bracket 6, while the first and second posts 62, 72 may be formed at the case 20.

In the above structure, the first positioning means (the projection 21a and the post 62 with the hole) are provided at two portions spaced from each other in the primary scanning direction N1. Similarly, second positioning means (the recess 71 and the post 72) are also provided at two portions spaced from each other in the primary scanning direction N1. With such an arrangement, the positioning of the image sensor head and the supporting bracket (especially in the primary scanning direction N1) can be performed more reliably than in the conventional structure (see FIG. 9).

As described above, the image sensor head 2A includes the light emitting assembly 3 and the light receiving assembly 4 in addition to the case 20. As shown in FIG. 2, the light emitting assembly 3 includes a point light source 31, a light guide 32, and a reflector 33. The light receiving assembly 4 includes a lens array 41 and a plurality of sensor ICs 42.

The case 20 may be formed of a black resin for preventing light reflection. The case 20 includes an accommodating portion 22 for accommodating the light guide 32 and the reflector 33, and also includes a groove 23 for holding the lens array 41. The underside of the case 20 is provided with a board 24.

The light source 31 is a resin package including one or more light emitting diodes (LED). Three types of LEDs, for example, red, green and blue LEDs may be used for reading a color print document. The light source 31 is mounted on one end (the right end in FIG. 2) of the board 24.

The light guide 32 efficiently guides light from the light source 31 toward the image reading area. The light guide 32 is made of an acrylic transparent resin such as PMMA. The light guide 32 includes a subsidiary area 32A and a main area 32B.

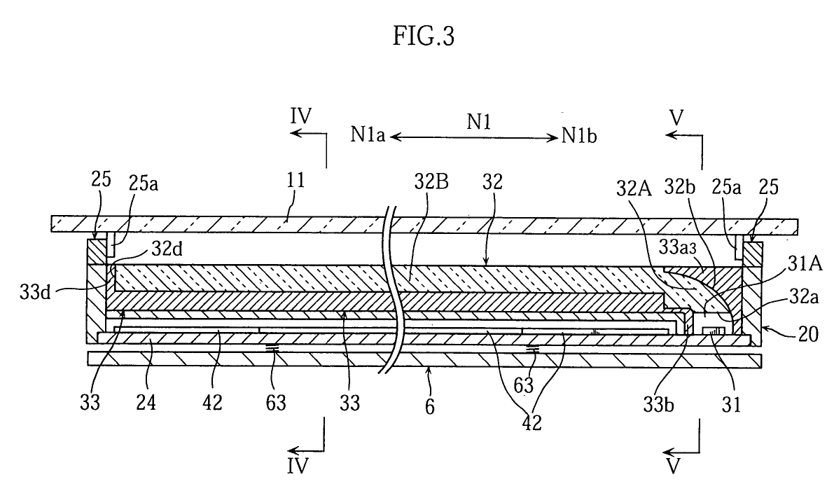

The subsidiary area 32A is positioned adjacent to the light source 31. The main area 32B is elongated in the primary scanning direction N1. As shown in FIG. 3, the subsidiary area 32A includes a flat surface 32a and a non-flat, curved surface 32b. The flat surface 32a faces the light source 31, while the non-flat surface 32b is positioned above the flat surface 32a. The light from the light source enters into the light guide 32 through the flat surface 32a, and then is reflected by the non-flat surface 32b, to travel toward the main area 32B.

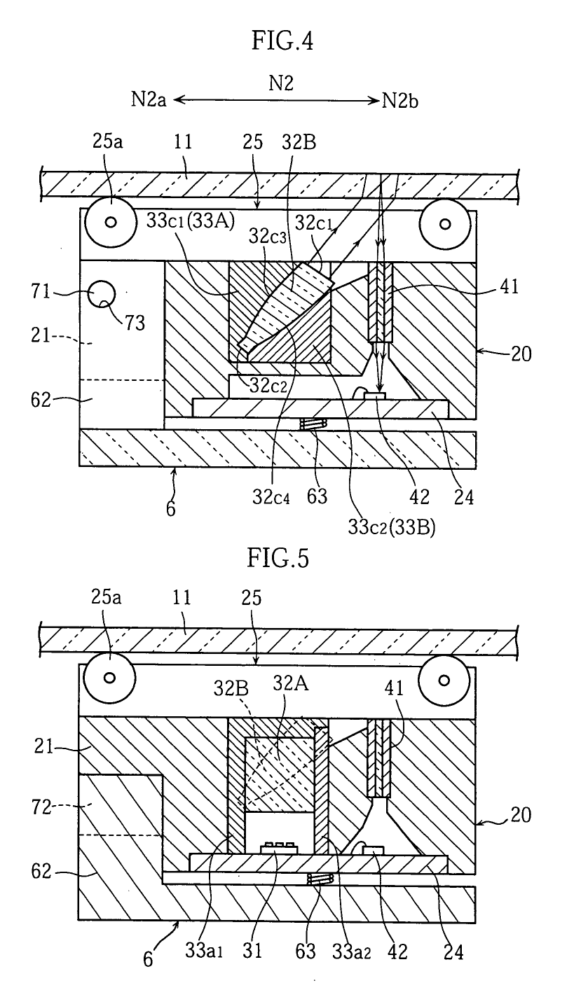

As shown in FIG. 4, the main area 32B includes first to fourth side surfaces 32c1, 32c2, 32c3, 32c4. The first side surface 32c1 is a flat surface facing the image reading area S. The second side surface 32c2 is provided with a scattering means (not shown) for causing scatter reflection of the light traveling in the light guide 32. The scattering means includes a plurality of recesses or protrusions which are circular in section, for example. The third and fourth side surfaces 32c3, 32c4 are curved surfaces facing to each other.

The light travels in the main area 32B, as being totally reflected on the four side surfaces. When striking upon the scattering means of the side surface 32c2, the light is reflected in various directions. When reflected upward, the light is then emitted out of the light guide 32 through the first side surface 32c1, and irradiates the image reading area.

The reflector 33 covers all the surfaces of the light guide 32 except the first side surface 32c1 and the light incident surface 32a. The reflector 33 is made of a white resin for improving the reflectance. As shown in FIG. 4, the reflector 33 includes a first member 33A and a second member 33B, for sandwiching the light guide 32 between the two members.

As shown in FIGS. 3 and 5, the reflector 33 includes walls 33a1 and 33a2 (see FIG. 5) for sandwiching the subsidiary area 32A in the secondary scanning direction N2, and also includes a wall 33a3 (see FIG. 3) abutting the reflecting surface 32b of the light guide 32. Further, the reflector 33 includes a wall 33b (see FIG. 3) facing the wall 33a3. As seen from FIG. 3, the four walls extend below the light incident surface 32a of the light guide 32, and form a space 31A for containing the light source 31. Due to this structure, the light from the light source 31 is prevented from leaking to the outside.

As shown in FIG. 4, the reflector 33 also includes a wall 33c1 abutting the side surfaces 32c2, 32c3 of the main area 32B, and a wall 33c2 abutting the side surface 32c4 of the main area 32B. Further, as shown in FIG. 3, the reflector 33 includes a wall 33d abutting an end surface 32d of the main area 32B. Due to this structure, the light traveling in the light guide 32 is prevented from leaking to the outside through any portion except the side surface 32c1.

The lens array 41 focuses the light reflected on the image reading area to the surface of the sensor ICs 42. The lens array 41 is made of a plurality of SELFOC lenses and a resin holder for holding the lenses.

Each of the sensor ICs 42 comprises a plurality of light receiving elements integrated in a semiconductor chip. The sensor IC 42 outputs image signals corresponding to the amount of received light, utilizing photoelectric conversion. As shown in FIG. 2, the sensor ICs 42 are mounted on the board 24, aligned longitudinally of the board.

As shown in FIG. 1, the image sensor head 2A is connected to the control panel 12 via a flexible cable 13. The flexible cable 13 is extensible according to the movement of the image sensor head 2A. The flexible cable 13 is connected to a connector 14 (see FIG. 2) provided at the board 24. The connector 14 includes a plurality of clips 14a engaging with the end of the board 24.

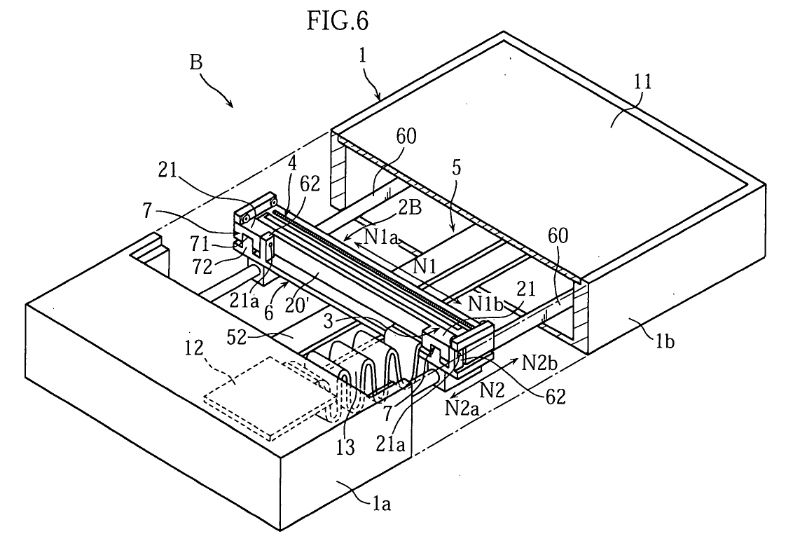

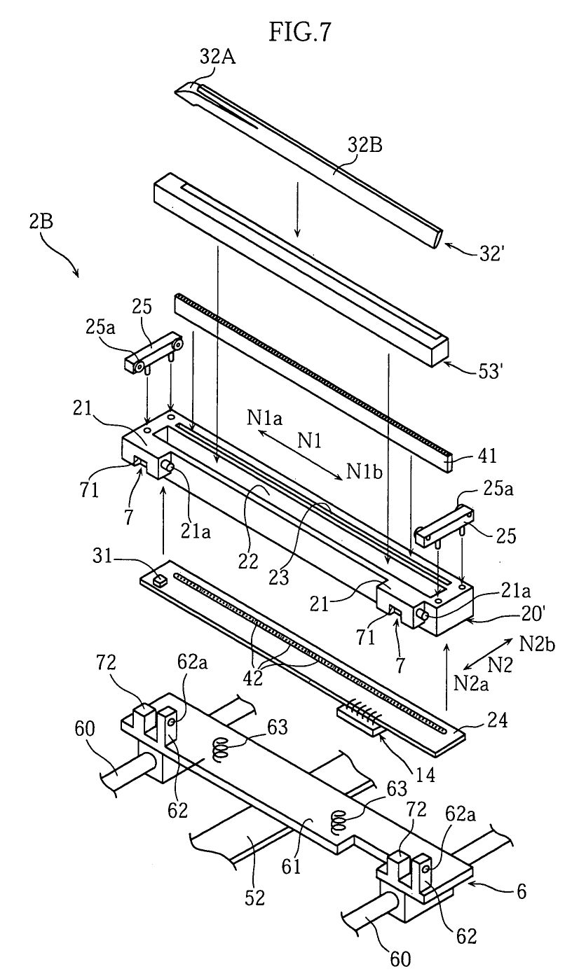

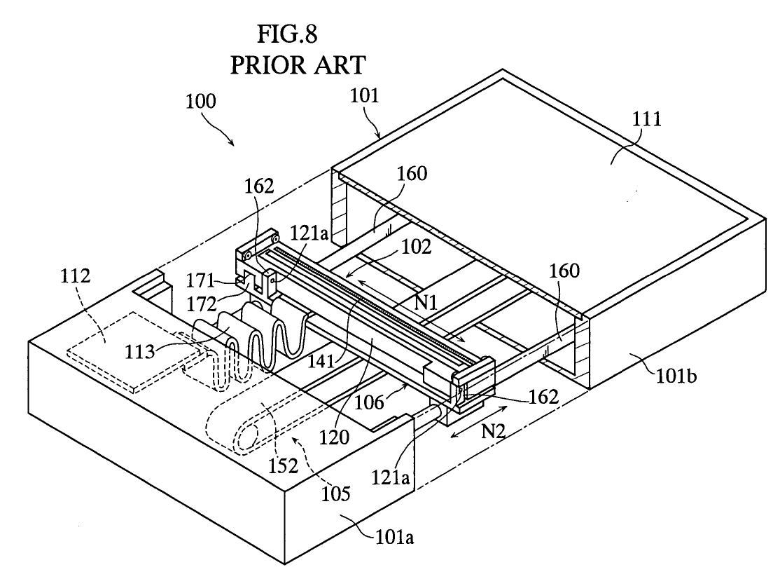

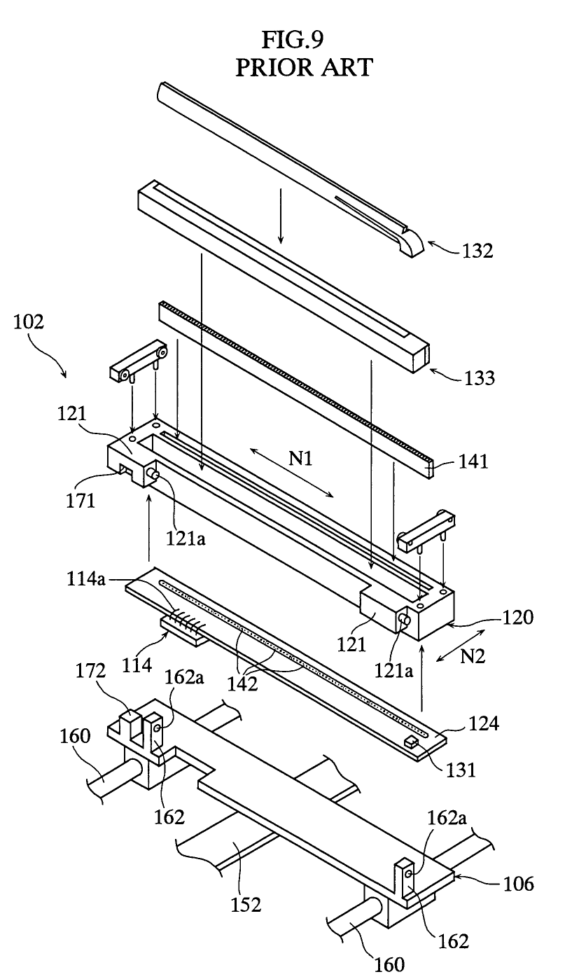

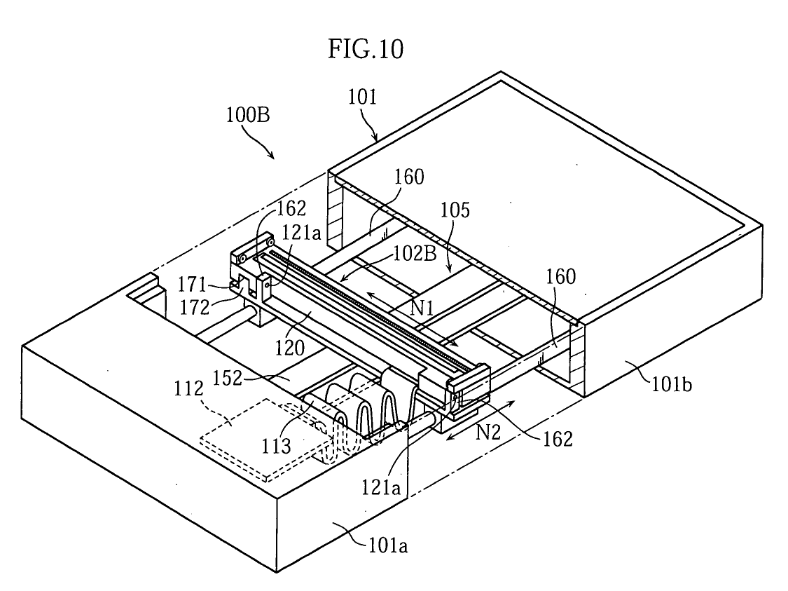

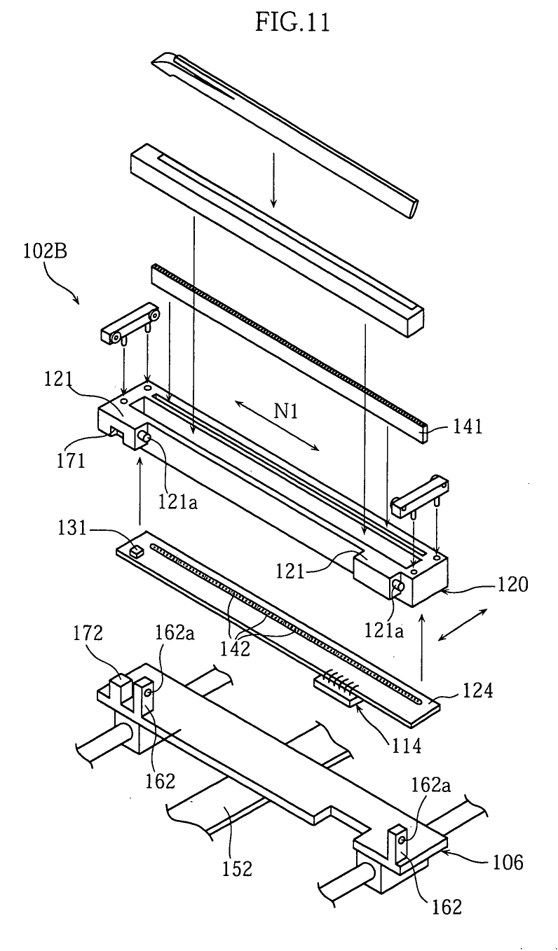

FIG. 6 illustrates an image scanner B according to a second embodiment of the present invention. FIG. 7 is an exploded perspective view illustrating an image sensor head 2B incorporated in the image scanner B. The second embodiment is basically the same in structure to the first embodiment, except that the control panel 12 is positioned differently from the first embodiment. As easily seen, the design of the other components is changed corresponding to the above positional change in the image scanner of the second embodiment.

Specifically, the control panel 12 of the second embodiment is positioned at the right side (N1b) in the primary scanning direction N1 of the housing 1 (see FIG. 6). Correspondingly, the connector 14 is attached to the right end of the board 24 (see FIG. 7). On the other hand, the light source 31 is provided at the left side (N1b) of the board 24. Regarding the positional relationship between the subsidiary area 32A and the main area 32B, the light guide 32′ of the image sensor head 2B is opposite in structure to the light guide 32 of the first embodiment. Correspondingly, the internal space in the reflector 33′ for accommodating the light guide 32′ is formed oppositely. However, this difference does not affect the outer configuration of the reflectors 33 and 33′. Thus, the form of the reflector accommodating portion 22 at the case is the same for the first and the second embodiments. This means, the case 20 (or 20′) can be used both in the first and in the second embodiments.

The present invention being thus described, it is obvious that the same may be modified in various ways. Such modifications should not be regarded as a departure from the spirit and scope of the invention, and all such modifications as would be obvious to those skilled in the art are intended to be included in the scope of the appended claims.

1. An image sensor head comprising:
a case elongated in a primary scanning direction and mounted on a bracket movable in a secondary scanning direction;
a light source accommodated in the case; and
light receiving elements accommodated in the case for receiving light from a document to be read;
wherein the case is provided with at least two positioning means for preventing the case from moving in the primary scanning direction relative to the bracket, these positioning means being spaced from each other in the primary scanning direction.

2. The image sensor head according to claim 1, wherein each positioning means comprises a recess into which a post provided at the bracket is fitted.

3. The image sensor head according to claim 1, further comprising: an elongated circuit board fixed to the case; and a connector supported by the board for external connection; wherein the light source is mounted on an end of the board, the connector being attached to another end of the board.

4. The image sensor head according to claim 3, further comprising an elastic member contacting with the board for urging the case.

5. The image sensor head according to claim 1, further comprising at least two cylindrical projections for preventing the case from moving in the secondary scanning direction relative to the bracket, wherein each cylindrical projection is positioned adjacent to a corresponding one of the positioning means, and projects in the primary scanning direction.

6. An image scanner comprising:
a case elongated in a primary scanning direction;
a bracket that supports the case and is movable in a secondary scanning direction;
a light source accommodated in the case;
light receiving elements accommodated in the case for receiving light from a document to be read;
a circuit board fixed to the case and supporting the light source and the light receiving elements;
a connector attached to the circuit board for external connection; and
a drive assembly for reciprocating the bracket in the secondary scanning direction;
wherein the case is provided with at least two positioning means for preventing the case from moving in the primary scanning direction relative to the bracket, these positioning means being spaced from each other in the primary scanning direction.

7. The image scanner according to claim 6, wherein each positioning means comprises a recess formed at the case, the bracket being provided with a post to be fitted into the recess.

8. The image scanner according to claim 6, the connector is arranged between the two positioning means and located at a position close to one of these positioning means.

9. The image scanner according to claim 6, further comprising a flexible cable connected to the connector.
